(19) United States
(12) Patent Application Publication
(10) Pub. No.: US 2005/0048892 A1
(43) Pub. Date: Mar. 3, 2005

(54) Beef steak cutting and preparation process and products

(76) Inventor: Robert Stockman, Palm Coast, FL (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/639,916

(22) Filed: Aug. 12, 2003

(51) Int. Cl. A22C 18/00

(52) U.S. Cl. 452/149

(57) ABSTRACT

A tenderloin steak product comprises a tenderloin beef section with at least a portion of attached bone. The steak is essentially a Porterhouse steak from which the top loin portion has been removed. A portion of the bone non-contiguous with the top loin is also preferably removed. The top loin and a portion of the bone can be removed by cutting the bone lengthwise along the long dimension of the tenderloin, to separate the two meat portions.

### BACKGROUND OF THE INVENTION

The invention relates to a new process for cutting and preparing beef steak and to the resulting products to provide an enhanced eating experience for a definite segment of the population.

Beef, especially steak, is enjoyed by vast numbers of people. Its appeal extends over generations and across cultures. Many individuals prefer particular product cuts and particular recipes. Butchers, meat specialists and cooks of all kinds attest to particular cuts and preparation procedures. However, even the best cuts of meat are often consumed in less than the best form and with less than an optimum of flavor and juiciness. Sometimes, regulatory efforts to properly identify an especially good cut of meat can work against a consumer because available cuts tend to follow standards.

An upper portion to the back and rear of a beef carcass, shown in the attached diagram of FIG. 1 as the Loin, comprises the short loin, which contains two main muscles: the tenderloin and the top loin. These two muscles are separated by a back bone having T-like cross sections, and are often cut together with the bone as T-bone or Porterhouse cuts.

Because T-bone and Porterhouse cuts comprise two distinctly different types of muscle meat, the same steak can have two distinct types of tastes and textures. Porterhouse steak is popular because of a large portion of tenderloin on one side of a bone and a strip of top loin on the other (e.g., often called a New York strip, when removed from the bone). The T-bone steak is similar in makeup, but has a smaller tenderloin section. The Porterhouse steak should have a tenderloin portion of at least 1.25 inches when measured in the direction parallel to the long or down stroke part of the T-shaped bone. The tenderloin portion, which is the tenderest and most costly beef portion, is thinnest closer to the head of the animal and gets thicker as you move toward the rear. Thus, Porterhouse cuts come from the section to the posterior of the T-bone cuts. Many people believe that the T-bone and the Porterhouse are the most flavorful of steaks.

New York strip steaks (top loin) cook well and are even preferred by some in their usual form of being separated from the bone and tenderloin. They are juicy and flavorful. While a highly desirable portion of meat, the tenderloin presents some challenges to optimal preparation when separated from one of these steak cuts. In fact, when the tenderloin is served without the top loin and is separated from the bone, as is standard, it tends to lack some flavor, and many recipes call for adding some fat, e.g., olive oil or a strip of bacon, to bring out its best flavor. Indeed, many people, who consider the tenderloin as a succulent piece of the Porterhouse steak, don't particularly care for it separately. This, however, is how it is served due, at least in part, to USDA Institutional Meat Purchase Specifications (IMPS) For Fresh Beef Products, Series 100, Effective Date—June 1996, wherein tenderloin is defined as absent bone and top loin portions.

There is a need in the art of meat cutting and preparation for a way to obtain a tenderloin cut of meat that retains the tenderness with which it is normally associated but yet has increased flavor and juiciness, which are typically lacking from tenderloin cuts as conventionally prepared.

### SUMMARY OF THE INVENTION

It is an object of this invention to provide a juicy and flavorful beef tenderloin steak which does not need fat addition prior to cooking.

It is another object of the invention to provide a method for preparing a juicy and flavorful beef tenderloin steak which does not need fat addition prior to cooking.

These and other objectives are achieved by the present invention, which provides a juicy and flavorful beef tenderloin steak which does not need fat addition prior to cooking and to methods for cutting and preparing such steaks. In the product form, the tenderloin section is separated, along with at least a portion of the bone, from the top loin portion. The product thus contains tenderloin steak and attached bone.

A number of preferred aspects of the invention will be described below.

### BRIEF DESCRIPTION OF THE DRAWINGS

The invention will be better understood and its advantages will be more apparent from the following detailed description, especially when read in conjunction with the accompanying drawings, wherein:

FIG. 1 is a schematic drawing of a beef carcass with major meat product sections labeled.

FIG. 2 is a schematic drawing of a portion of a beef carcass showing the location of the short loin section and accompanying bone structure.

FIG. 3 is a top plan view of a Porterhouse steak showing its parts and a representative line for cutting to make the product of the invention.

FIG. 4 is a top plan view of a Porterhouse steak showing its parts and an alternate line for cutting to make the product of the invention.

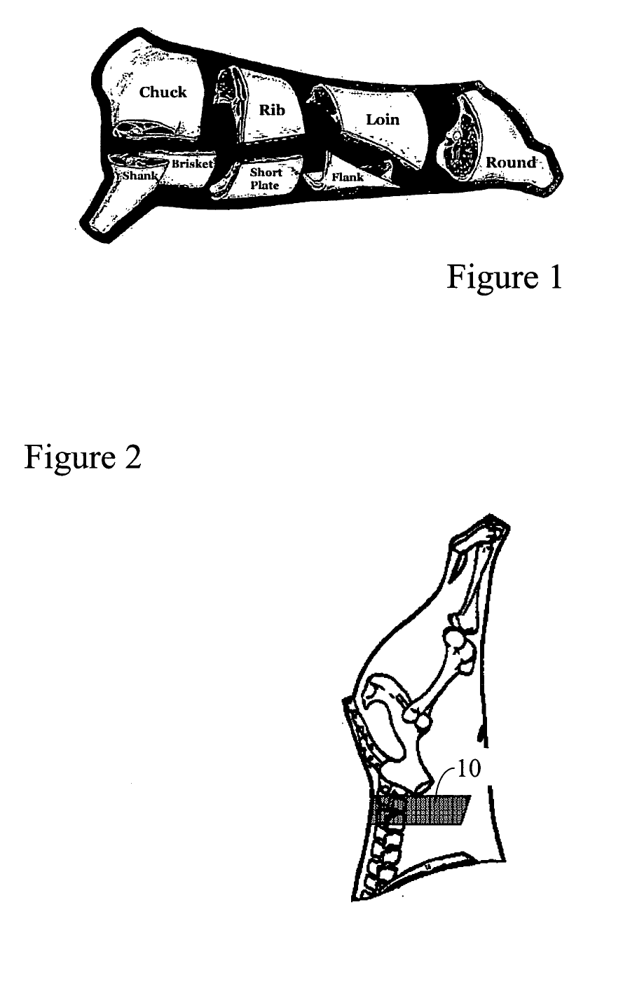

### DETAILED DESCRIPTION OF THE INVENTION

For purposes of precision in describing the invention to persons skilled in the art, Porterhouse and other meat products are defined here by the descriptions provided by the USDA in the Institutional Meat Purchase Specifications (IMPS) For Fresh Beef Products, Series 100, Effective Date—June 1996. This reference defines a Beef Loin Porterhouse Steak as a steak cut from the beef loin and having a tenderloin muscle that must be at least 1¼ when measured through the center of the tenderloin muscle parallel to the backbone, excluding any surrounding fat. This reference also defines the available tenderloin products as those fully separated from the bone.

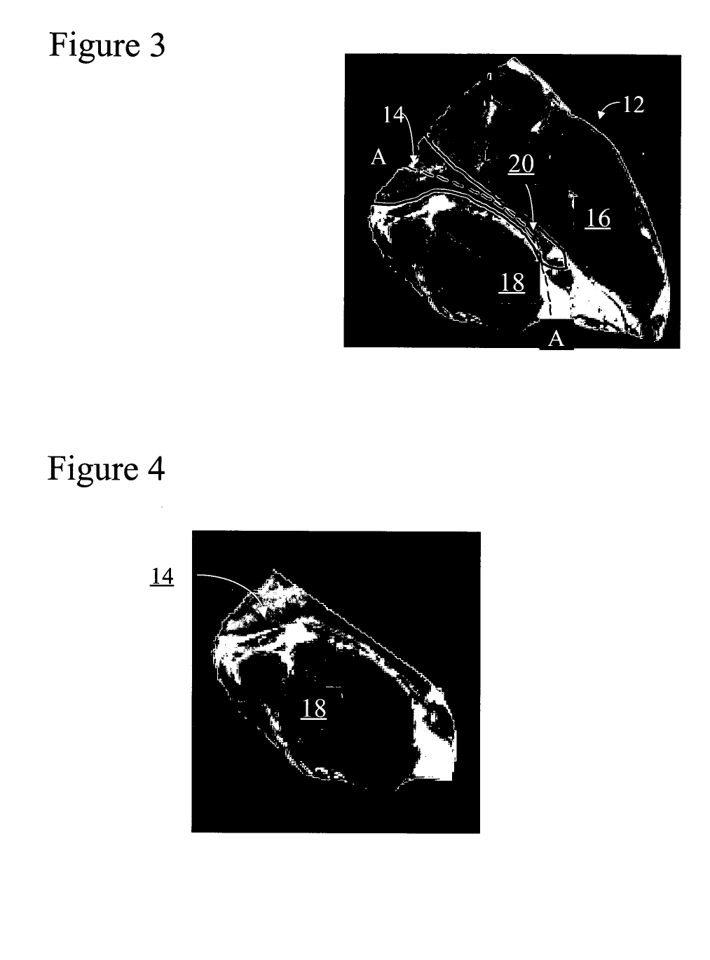

The Porterhouse steak is cut from the short loin 10 (see FIG. 2) nearest the sirloin. The short loin 10 is the anterior portion of the loin, which is separated from the sirloin by a straight cut which passes at a point immediately in front of (anterior to) the pin bone (ilium or tuber coxae). A Porterhouse steak is shown in FIG. 3 as 12 and is cut from that portion of the short loin 10, which is separated from the T-bone by a straight cut passing immediately in front of (anterior to) the tip of the gluteus medius muscle and approximately through the center of the body of the 4th lumbar vertebra. The Porterhouse, like the rib eye, extends along the animal's rib from neck toward the rear portion of the animal

A Porterhouse beefsteak typically contains a T-shaped bone 14 (shown outlined in solid black in FIG. 3) with meat on either side of the long (down stroke portion 20) T-bone portion. On one side of the bone 14 is the strip 16 of top loin and on the other is the tenderloin 18. This combination of a large portion of tenderloin 18 on one side of bone 14 and a strip of top loin 16 on the other is known to be highly flavorful and juicy. The tenderloin portion, which is the most desirable and hence most valuable, is thinner closer to the head of the animal and gets thicker toward the rear. According to the above IMPS description, it is available wholly separated from bone and top loin muscle meat.

According to the invention, the tenderloin section 18 is cut to include at least a portion of the bone 14, but removed from the top loin portion 16. The product thus contains tenderloin steak 18 and naturally-attached bone 14. The excess fat and some meat, as in a tail portion (not shown) usually part of a Porterhouse steak appearing at the long end of the bone 14, can be trimmed as desired.

In one embodiment, as shown in FIG. 3, the strip 16 of top loin is removed from the tenderloin portion 18 by cutting the bone 14, such as along line A-A, on the down stroke portion (20) of the T-bone where the T-shaped bone portion 14 is cut along the long dimension of the tenderloin 18 to leave a portion of the bone 14 attached to the meat on opposite sides. The long dimension is that distance from the top of the T-shaped bone toward its tip. In the drawing, the bone is not as long as the long dimension of the tenderloin, but in some cases it is longer. This embodiment again provides the tenderloin portion 18 attached to the bone 14. The amount of bone should be substantial, typically comprising at least 25% of the mass of the bone, and can include essentially all of the bone, but should be essentially free of top loin meat. In some situations, a butcher may leave a small portion of top loin meat on the bone due to attempts to rapidly process the meat, but the amount will not typically exceed 10 to 15% of the original weight of the top loin.

In another form of the invention, the strip 16 of top loin is simply removed from the bone 14. This simple cutting leaves the tenderloin portion 18 attached to the bone 14 and greatly enhances the flavor of the tenderloin section. As shown in FIG. 4, the strip of top loin has been removed first and then a portion of the bone 14 non-contiguous with the tenderloin has been removed with a simple cut. The removed portion of the bone may be part of the top of the “T” that is naturally contiguous with the top loin. The piece cut in this manner has a distinctive shape as well as improved flavor.

The tenderloin steak product of the invention should be no thinner than ½ inch and is desirably up to about 2 inches in thickness. The thicker steaks, as cut, are often lightly pounded to reduce their thickness by from about 10 to about 40%, e.g., from about 20 to about 30%. The length of the tenderloin should be at least about 1 inch and has no maximum.

The steak products made by both of these procedures is greatly improved over conventional tenderloin steaks and can be cooked to perfection without the need for additional fat or oil applied prior to cooking. It is another advantage of the invention that there is no need for sauce, dressing or topping of any kind to restore moistness or enhance flavor.

The invention can also be viewed from the perspective of steak preparation as a process including cooking. Thus, the meat preparation aspect of the invention will include the above processing to cut the steak portion and be followed by a cooking step which provides heat sufficient to brown the exterior and at least increase the temperature of the meat interior with the natural bone at least partially intact.

The above description is intended to enable the person skilled in the art to practice the invention. It is not intended to detail all of the possible modifications and variations which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement or sequence which is effective to meet the objectives intended for the invention, unless the context specifically indicates the contrary.

1. A tenderloin steak product comprising a tenderloin beef section with at least a portion of naturally-attached bone and essentially free of top loin meat.

2. A tenderloin steak according to claim 1 having excess fat trimmed therefrom.

3. A tenderloin steak according to claim 1 comprising essentially a Porterhouse steak from which the top loin portion has been removed.

4. A tenderloin steak according to claim 3 wherein a portion of the bone non-contiguous with the tenderloin beef section is removed.

5. A tenderloin steak according to claim 1 comprising a tenderloin section of meat attached to a T-shaped bone portion cut along the long dimension of the tenderloin.

6. A process for preparing a tenderloin steak cut, comprising removing attached top loin muscle meat while leaving at least a portion of bone attached to the tenderloin.

7. A process for preparing a tenderloin steak cut, according to claim 6, and further comprising removing a portion of the bone which is non-contiguous with the tenderloin.

8. A process according to claim 6 wherein a portion of the bone is removed by cutting it along the long dimension of the tenderloin.

9. A process according to claim 6 which includes the further step of cooking by providing heat sufficient to brown the exterior and at least increase the temperature of the meat interior while at least a portion of the natural bone remains attached to the tenderloin.

10. A product as produced by claim 6.

11. A product as produced by claim 7.

12. A product as produced by claim 8.

13. A product as produced by claim 9.
